(19) United States
(12) Patent Application Publication
(10) Pub. No.: US 2026/0065598 A1
(43) Pub. Date: Mar. 5, 2026

(54) SYSTEM AND METHOD FOR GENERATING AN IMAGE OF A VEHICLE

(71) Applicant: Carvana IPHC, LLC, Tempe, AZ (US)

(72) Inventors: Brian Shaler, Tempe, AZ (US); Antoine Vaucamps, Tempe, AZ (US); Remy Cilia, Tempe, AZ (US); Bruno Francois, Tempe, AZ (US)

(73) Assignee: Carvana IPHC, LLC, Tempe, AZ (US)

(21) Appl. No.: 18/819,992

(22) Filed: Aug. 29, 2024

(51) Int. Cl. G06T 19/00; G06T 7/70; G06T 13/20

(52) U.S. Cl. CPC G06T 19/00; G06T 7/70; G06T 13/20; G06T 2207/20081; G06T 2207/30244; G06T 2207/30252

(57) ABSTRACT

Systems and methods including one or more processors and one or more non-transitory storage devices storing computing instructions configured to run on the one or more processors and perform acts of estimating one or more camera positions using the one or more images of the vehicle; performing a first training process for a predictive algorithm using the one or more images of the vehicle; after the first training process has started, performing a second training process for the predictive algorithm using the one or more images of the vehicle, wherein the second training process is different from the first training process; generating one or more novel views of the vehicle using the predictive algorithm; after the second training process has started, coordinating displaying at least one image of the one or more novel views of the vehicle. Other embodiments are disclosed herein.

### TECHNICAL FIELD

This disclosure generally relates to generating true to life reproductions of an automobile in a digital image, and more specifically, to generating true to life 3D models of automobiles.

### BACKGROUND

The online advertising and online selling of vehicles is a major industry, allowing buyers to see a wide variety and wide selection of vehicles for sale. Vehicles may be posted on websites and shared via a variety of platforms by an individual vehicle owner or vehicles may be posted by a business that buys and sells vehicles. Such a business may have a large volume of vehicles that are typically listed for sale. The major components of these vehicle listings are the photographs included with the listings. To be successful, photographs of the vehicles should be high quality and true to life. Many angles and aspects of each vehicle should be captured to allow potential buyers to gain an understanding of each vehicle's condition and appearance. Consistency between photographs is also important to allow potential customers to compare vehicles. However, for a business with a large volume of vehicles that are being listed, detailed and consistent photography may be difficult, time-consuming, and expensive. These problems can be further exacerbated when complex manipulations are performed using images of the automobiles. For example, generating models of and/or animating a vehicle can cause a system displaying the vehicle to shift between multiple true to life views of the vehicle, thereby causing the system to perform data intensive rendering tasks.

Therefore, a need exists for a system and method to streamline and ease the photographing of hard-to-reach vehicle aspects and angles.

### SUMMARY

A number of embodiments can include a system. The system can include one or more processors and one or more non-transitory computer-readable storage devices. The one or more non-transitory computer-readable storage devices can store computing instructions. The computing instructions can be configured to communicate with the one or more processors and cause the one or more processors to perform estimating one or more camera positions using the one or more images of the vehicle; performing a first training process for a predictive algorithm using the one or more images of the vehicle; after the first training process has started, performing a second training process for the predictive algorithm using the one or more images of the vehicle, wherein the second training process is different from the first training process; generating one or more novel views of the vehicle using the predictive algorithm; after the second training process has started, coordinating displaying at least one image of the one or more novel views of the vehicle.

Various embodiments include a method. The method can be implemented via execution of computing instructions configured to run at one or more processors and/or configured to be stored at non-transitory computer-readable media The method can comprise estimating one or more camera positions using the one or more images of the vehicle; performing a first training process for a predictive algorithm using the one or more images of the vehicle; after the first training process has started, performing a second training process for the predictive algorithm using the one or more images of the vehicle, wherein the second training process is different from the first training process; generating one or more novel views of the vehicle using the predictive algorithm; after the second training process has started, coordinating displaying at least one image of the one or more novel views of the vehicle.

Various embodiments can include an article of manufacture. The article of manufacture can include a non-transitory, tangible computer readable storage medium. The non-transitory, tangible computer readable storage medium can store instructions that, in response to execution by a computer, cause the computer to perform operations comprising estimating one or more camera positions using the one or more images of the vehicle; performing a first training process for a predictive algorithm using the one or more images of the vehicle; after the first training process has started, performing a second training process for the predictive algorithm using the one or more images of the vehicle, wherein the second training process is different from the first training process; generating one or more novel views of the vehicle using the predictive algorithm; after the second training process has started, coordinating displaying at least one image of the one or more novel views of the vehicle.

### BRIEF DESCRIPTION OF THE DRAWINGS

To facilitate further description of the embodiments, the following drawings are provided in which:

FIG. 1 illustrates a flowchart for an exemplary method, according to various embodiments;

FIG. 2 illustrates a representative block diagram of an exemplary system, according to various embodiments; and

FIG. 3 illustrates a representative block diagram of an exemplary system, according to various embodiments;

FIG. 4 illustrates a flowchart for an exemplary method, according to various embodiments; and

FIG. 5 illustrates an exemplary user interface, according to various embodiments.

### DESCRIPTION OF EXAMPLES OF EMBODIMENTS

In various embodiments, the functions can provide a practical application and several technological improvements. In various embodiments, the functions can provide for automated generation of true to life images of a vehicle. These functions can provide a significant improvement over conventional approaches of generating images of a vehicle, such as manual generation of images by a graphic artist or simply performing a videotaped walkabout of a vehicle. For example, millimeter level details on a vehicle can be identified, modeled, and viewed. These small, true to life details can allow for enhanced reproduction and identification of elements such as the contours of vehicle emblems, contours of vehicle rims (for wheeled vehicles), damage (e.g., scratches, dents, dings, scuffs), aftermarket additions (decals, body kits, etc.), or identification numbers. In various embodiments, the functions can beneficially generate true to life images of a vehicle based on dynamic information. For example, the functions can be used to generate bespoke true to life images of a vehicle for different makes and models in an automated workflow. In this way, these functions can avoid or minimize problems with slow or inconsistent generation of true to life images of a vehicle by a graphic artist.

In various embodiments, the functions can be used continuously at a scale that cannot be reasonably performed using manual functions or the human mind. For example, these functions can be implemented in an automated workflow that allows multiple true to life images of a vehicle to be generated in series. In addition, multiple true to life images of a vehicle can be generated at the same time using a distributed processing system. In various embodiments, the functions can solve a technical problem that arises only within the realm of computer networks, as digital images do not exist outside the realm of computer networks.

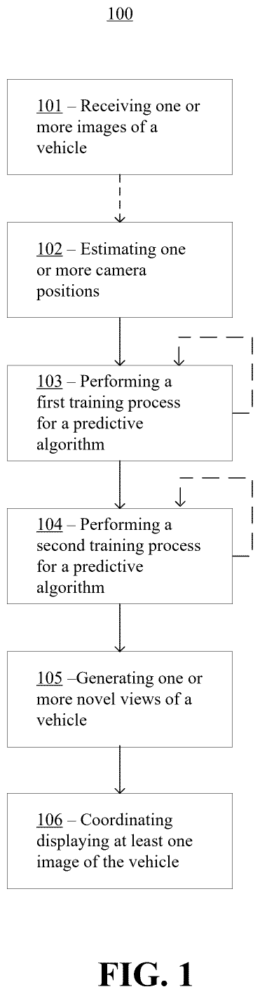

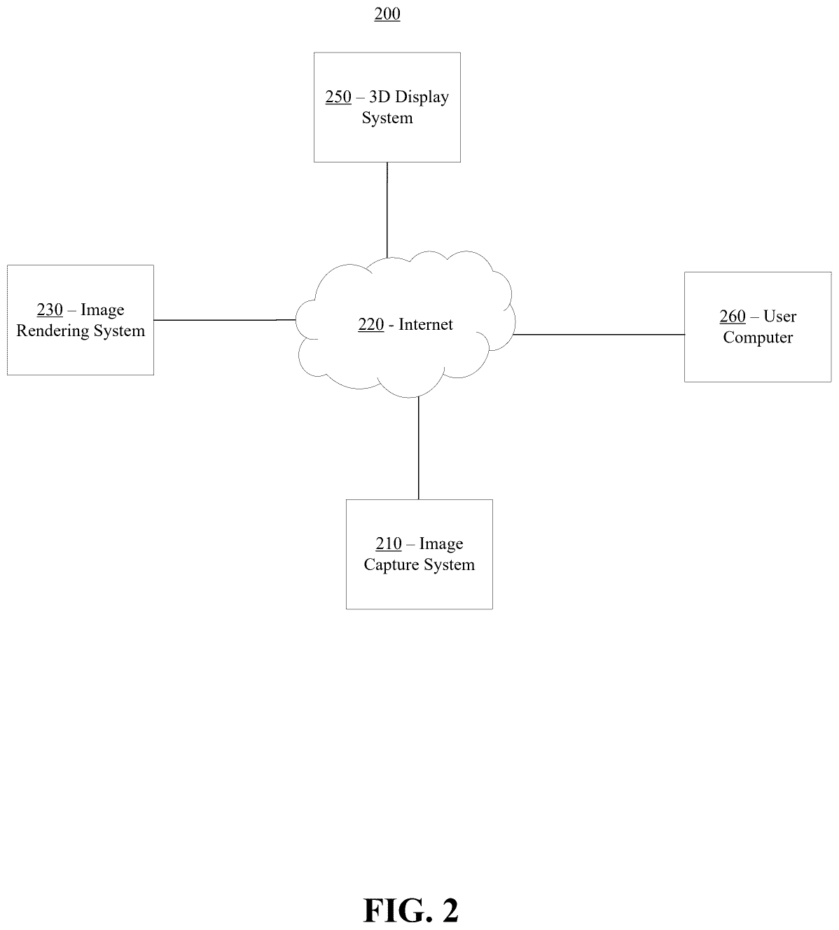

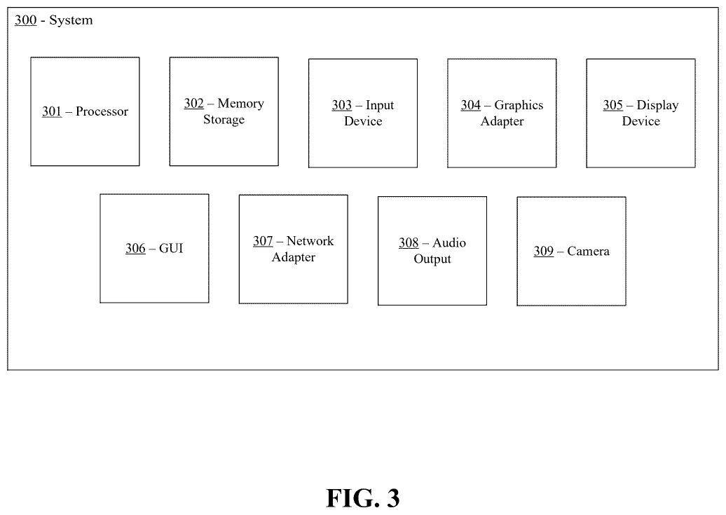

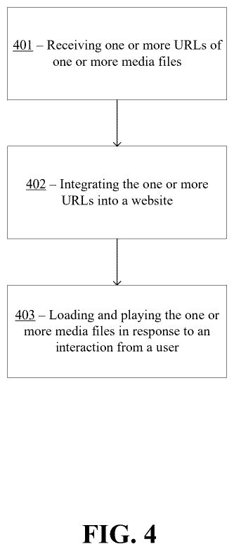

FIG. 1 illustrates a flow chart for a method 100, according to various embodiments. Method 100 is merely exemplary and is not limited to the embodiments presented herein. Method 100 can be employed in many different embodiments or examples not specifically depicted or described herein. In various embodiments, the activities of method 100 can be performed in the order presented. In other embodiments, the activities of method 100 can be performed in any suitable order. In still other embodiments, one or more of the activities of method 100 can be combined or skipped. In various embodiments, system 200 (FIG. 2) or system 300 (FIG. 3) can be suitable to perform method 100 and/or one or more of the activities of method 100. In these or other embodiments, one or more of the activities of method 100 can be implemented as one or more computer instructions configured to run at one or more processing modules and configured to be stored at one or more non-transitory memory storage modules. Such non-transitory memory storage modules can be part of a computer system such as image capture system 210, image rendering system 230, 3D display system 250, and/or user computer 260 (FIG. 2). The processing module(s) can be similar or identical to the processing module(s) described above with respect to computer system 300 (FIG. 3). In various embodiments, method 100 can be performed in parallel, before, after, or as a part of method 400 (FIG. 4). In various embodiments, one or more activities of method 100 can be inserted into and/or combined with all of or portions of method 400 (FIG. 4).

In various embodiments, method 100 may comprise an activity 101 of receiving one or more images of a vehicle. Images of a vehicle (e.g., car, truck, motorcycle, boat, airplane, etc.) can be taken in a 3D scanner. For example, an EinScan SE Desktop 3D Scanner, an Afinia EinScan-Pro 2X PLUS Handheld 3D Scanner, and/or an EinScan-SE White Light Desktop 3D Scanner can be used. A 3D scanner can comprise a photography studio configured to create 3D displays. For example, U.S. Pat. No. 10,063,758 and application. Ser. Nos. 18/331,605, 18/545,424, 18/544,930, 18/535,071, 18/430,231, 18/789,315, and 17/692,498, which are incorporated herein by this reference in their entirety, describe representative photography studios configured to capture images of a vehicle.

In various embodiments, a 3D scanner can comprise a stage where a vehicle to be photographed is placed. The stage can be located in an interior chamber of a 3D scanner and/or can be placed in an approximate center of a 3D scanner. A stage can be configured to turn a vehicle while a camera captures images. A camera in a 3D scanner can be held in a fixed position or moved around a vehicle while images are captured. For example, a camera can be mounted on a robotic arm or a rail and moved around a vehicle. An interior chamber of a 3D scanner can be configured to project uniform lighting onto a stage. One or more images can be taken in other capture environments that are not a 3D scanner. For example, one or more images can be taken outside or in a building using a handheld camera, a smartphone, a wearable electronic device, and/or some other portable electronic device outfitted with an image sensor (e.g., user computer 260 (FIG. 2)). In various embodiments, a 3D scanner can be a part of and/or controlled by image capture system 210 (FIG. 2).

In some embodiments, an autonomous vehicle (AV) mounted camera can be used to capture images of a vehicle. An AV can be moved in an approximately circular or elliptical path around a vehicle. The AV can move a camera so that the camera focuses on the vehicle while the AV travels along the path. In many embodiments, an AV can repeat a path around a vehicle at multiple altitudes, heights, and/or depths to capture additional images. In other embodiments, an AV can be outfitted with multiple cameras at different altitudes, heights, and/or depths to capture the additional images.

One or more images can be taken radially around (e.g., around a central axis) of a vehicle. In this way, the one or more images can be of the vehicle from multiple angles, thereby giving a 360 degree view around the one or more objects when combined. When a 3D scanner is used, various functions can be used to obtain radially captured images. For example, one or more cameras can be mounted to a rail along the circumference of an interior chamber, and these cameras can then be moved around the object while taking photographs. As another example, a stage of a 3D scanner can be configured to rotate while one or more cameras mounted at fixed positions take photographs. One or more cameras in a 3D scanner can be set at multiple levels to capture varied angles of a vehicle at different altitudes, heights, and/or depths. For example, a first camera can be placed on a floor, a second camera can be placed above a vehicle (e.g., directly above and/or angled down at the vehicle), and a third can be placed between the first and the second cameras. In embodiments where a portable electronic device is used to take the one or more images, the portable electronic device can be instructed by a software application stored on the portable electronic device to move around an object while taking pictures.

In various embodiments, each image of the one or more images can be associated with a position of a camera that took the image. For example, sensor data (e.g., gyroscope data, accelerometer data, compass data, global positioning system (“GPS”) data) or augmented reality data (e.g., structure-from-motion data) can be associated with each image. Position data for an image can be incorporated into image metadata, sent as a separate file, and/or estimated using one or more structure from motion functions. For example, position data can be estimated using the well-known COLMAP pipeline of algorithms, which can be located at <https://colmap.github.io/>. Position data can define a value for a camera's six degrees of freedom (e.g., forward/back, up/down, left/right, yaw, pitch, roll), a camera's coordinate position (e.g., on an x, y, z coordinate plane), and/or a camera's focal length. In embodiments where a 3D scanner is used, this positional information can be known in advance (e.g., by preconfiguring a camera's position and orientation) or computed while a vehicle is being photographed. In embodiments where a portable electronic device is used, one or more location tracking modules (e.g., accelerometers, Bluetooth beacons, Wi-Fi location scanning, GPS, etc.) can be used to determine a position of the camera in space. In this way, positional data for each image of the one or more images can be used to orient a camera about the object. One or more images can be captured in and/or received from an image capture system 210 (FIG. 2) and/or user computer 260 (FIG. 2). In these or other embodiments, an image capture system 210 (FIG. 2) can be a part of and/or integrated with a 3D scanner, as described above. In various embodiments, image capture system 210 (FIG. 2) can comprise a software application installed on a computer system (e.g., system 300 (FIG. 3) or user computer 260 (FIG. 2)).

While positional data received in activity 101 can aid in generating true to life images of an automobile (e.g., images that show millimeter level details), variations among this data can cause problems when it is incorporated into various downstream algorithms. For example, variations in camera position due to vibrations, imperfect paths around a vehicle, or changes in speed around a vehicle can cause degradations of details generated in novel views. As another example, captures where a vehicle is rotated and a camera is stationary can generate insufficient or improperly formatted positional data for downstream algorithms. Therefore, in various embodiments, method 400 can comprise activity 102 of estimating one or more camera positions. In some embodiments, positional data for only one physical camera is used in activity 102. For example, in embodiments where only one camera is moved radially around an object, positional data for only one camera can be used to estimate. Estimated camera positions can be created for each photograph using positional data received in activity 101. A specific estimation can be generated by modeling each image of a vehicle as being from a separate camera surrounding a static vehicle. For example, as a photographer moves a camera around a vehicle, its path around the vehicle can be recorded and a position of the camera for each image can then be estimated relative to the vehicle. As another example, when a vehicle is rotated in front of a stationary camera, each shot can be modeled as a separate camera lying on a circumference of a circle around the vehicle. As the vehicle rotates, a rotational movement (e.g., in degrees, radians, time, percentage of total, etc.) of the vehicle is recorded for each image and then can be converted into a position for a camera relative to the vehicle.

In various embodiments, method 100 can comprise an activity 103 of performing a first training process for a predictive algorithm. A predictive algorithm can be understood as a computational model designed to predict new views of a vehicle from different angles or perspectives. In this way, a predictive algorithm can be used to generate a 3D scene (e.g., a portion of a video) from 2D still images. A number of different predictive algorithms can be used in activity 103. For example, a point cloud rendering technique and/or a volumetric rendering technique can be used. Point clouds can be seen as collections of 3D points that represent a vehicle. Novel views of a vehicle can be synthesized by tracking and/or projecting the point cloud from different angles and then applying various functions to fill in gaps in a novel view or smooth out a novel view so that it is more true to life. Point clouds can therefore function as sparse representations of the 3D geometry of a vehicle and offer a flexible and efficient way to capture and render true to life details of a vehicle. Volumetric rendering functions involve modeling vehicles as volumes rather than surfaces or points. For example, a voxel grid is a volumetric rendering technique that can store properties of a vehicle image as scalar or vector fields. The voxel grid structure then acts as a representation of the 3D geometry of the vehicle and can be tracked across images to estimate new views of the vehicle.

In various embodiments, a predictive algorithm can comprise Gaussian splatting (GS). GS incorporates elements of both point cloud and volumetric rendering functions. This is because GS not only models a vehicle as a point cloud, but also models it as a distribution across a field for the vehicle. In GS, a point cloud for a vehicle can be generated for each image and/or a point cloud can be supplied from an external source (e.g., a point cloud can be generated from a different software module or computer system and/or a point cloud can be supplied by a third party). A point cloud can be generated by extracting 3D points from the image using a camera's six degrees of freedom (e.g., forward/back, up/down, left/right, yaw, pitch, roll), a camera's rotational movement, a camera's coordinate position (e.g., on an x, y, z coordinate plane), and/or a camera's focal length. This data can be inserted into methods such as multi-view stereo, structure from motion, or depth estimation to generate a point cloud. Each point in the point cloud can have a 3D coordinate in the image (x, y, z) and additional attributes such as color (RGB), opacity, reflectivity, roughness, specularity, and/or metalness information. In many embodiments, a point cloud can be randomly generated for two or more images. Point clouds can be used as is and/or refined through one or more downstream algorithms (e.g., an optimization algorithm) until it represents sufficient 3D structure for a car. Point clouds can be used to track a position of a 3D point in space and can also aid in generating novel views of a vehicle.

GS can proceed by representing each point as a Gaussian distribution in 3D space. This Gaussian distribution is characterized by a mean (e.g., the point's position) and a covariance matrix that defines its spread (e.g., how the point's influence decays in a space surrounding the point). Each Gaussian distribution is then splatted onto the image plane by placing the Gaussian at its point on the point cloud. The placed splat can comprise a blurred spot or footprint that reflects the Gaussian's spread in 3D space. As Gaussians from different points overlap in the image plane, their contributions are blended together. In various embodiments, blending Gaussians can comprise summing up color and opacity values for overlapping Gaussians and rendering their color and opacity while taking into account their distances from each other and spreads. Other properties can also be blended in (e.g., reflectivity, roughness, specularity, and/or metalness) to enhance and/or render the image. Spherical harmonics can also be used to blend Gaussians. In many embodiments, spherical harmonics can comprise one or more mathematical functions that define properties of a surface that vary over a spherical domain. In GS, spherical harmonics can be used to model how light interacts with a vehicle depending on a viewing angle. For example, viewing angle dependent colors can be shown in GS by using spherical harmonics, even when the surface is reflective (e.g., a surface of a vehicle). In this way, a smooth, continuous, and true to life novel view can be generated, rather than one composed of discrete points.

In various embodiments, training a predictive algorithm can comprise estimating internal parameters of a model configured to generate a novel view of a vehicle. In various embodiments, a predictive algorithm can be trained using labeled training data, otherwise known as a training dataset. In various embodiments, a training dataset can comprise images of an automobile. In the same or different embodiments, a pre-trained predictive algorithm can be used, and the pre-trained algorithm can be re-trained on the labeled training data. In various embodiments, the predictive model can also consider both historical and dynamic input from an image capture system. In this way, a predictive algorithm can be trained iteratively as data from the image capture system is added to a training data set. In various embodiments, a predictive algorithm can be iteratively trained in real time as data is added to a training data set. In various embodiments, a predictive algorithm can be trained, at least in part, on a single vehicle's images or the single vehicle's images can be weighted in a training data set. In this way, a predictive algorithm tailored to a single vehicle model can be generated. In the same or different embodiments, a machine learning algorithm tailored to a single vehicle model can be used as a pre-trained algorithm for a similar vehicle. In several embodiments, due to a large amount of data needed to create and maintain a training data set, a predictive algorithm can use extensive data inputs to generate a novel view. Due to these extensive data inputs, In various embodiments, creating, training, and/or using a predictive algorithm configured to generate a novel view of a vehicle cannot practically be performed in the mind of a human being.

While a predictive algorithm can be used to generate high quality, highly detailed novel views of a vehicle, many can suffer from slow speeds and a large drains on computing resources. Specifically, excessive computing resources are drawn upon when generating and using point clouds due to the number of datapoints (e.g., a camera's six degrees of freedom and/or a camera's coordinate position) needed. One or more steps in a multi-step training process can be used to reduce and/or eliminate this bottleneck. A first training process can be used to reduce the number of variables considered during training of a predictive algorithm. A predictive algorithm can first be trained on a lower number and/or lower resolution of vehicle images. As a first example, a subset of images and their associated camera positions can be used to train a GS algorithm, thereby reducing the processing power needed. As a second example, a lower number of splats can be generated and/or blended, thereby reducing the processing power needed. As a third example, spherical harmonics (e.g., view dependent color data) can be disabled to simplify calculations needed to generate a point cloud.

As a fourth example, training data can be rendered on a background containing color (e.g., RGB) noise and/or one or more actual images that has been segmented and had its background replaced with color (e.g., RGB) noise. A color noise background also improves camera alignment by focusing downstream algorithms (e.g., optimization algorithms and/or their cost functions) on a vehicle instead of a background. As a fifth example, splats and/or ground truth images of a vehicle can be colored only one color (e.g., black), thereby allowing downstream algorithms (e.g., optimization algorithms and/or their cost functions) to analyze only a silhouette of a vehicle. In this way, a sparse representation of a vehicle's 3D structure can be easily and quickly generated. This, then allows downstream algorithms to be run faster and more efficiently.

A first training process can also comprise optimizing positional data of a camera used to photograph one or more images of a vehicle. Camera positions (whether estimated or actual) can be optimized using one or more optimization algorithms. An optimization algorithm can be used to vary one or more elements of a camera's position, thereby slightly changing an image output by a predictive algorithm. These predicted images can then be compared to a ground truth image (e.g., an image taken by a 3D scanner at that position) via a cost function.

Cost functions, also known as loss functions or objective functions, can be used in predictive algorithms to quantify a difference between a predicted (e.g., novel) view of a vehicle and an actual image of the vehicle. Cost functions guide an optimization process by helping a predictive model improve its generation of novel views. A number of cost functions can be used. For example, one or more of a mean absolute error (MAE) and/or a structural similarity index measure (SSIM) can be used. In embodiments where two or more cost functions are used, their outputs can be combined before being evaluated by an optimization algorithm. An influence of each cost function on the combined output can be varied in a number of ways. For example, two or more cost functions can be combined as a weighted average. In more specific examples, a weighted average of 80% MAE and 20% SSIM.

MAE measures an average absolute difference between a predicted view of a vehicle and an actual image of the vehicle. MAE can have a number of advantages over other cost functions. For example, an absolute value term in MAE allows it to treat all errors equally, thereby making large outliers less influential in its analysis. Further, MAE pairs well with optimization algorithms such as gradient descent due to its linearity because its gradient (a derivative of the cost function) is constant at each data point. MAE can be understood as being a mean absolute differences between predicted values for an image of a vehicle ŷᵢ and actual values yᵢ for an image of a vehicle for all data points i (e.g., pixels) in a dataset. Mathematically it can be expressed as:

$$MAE = \frac{1}{n} {\sum }_{i = 1}^{n} \vert {y}_{i} - {\hat{y}}_{i} \vert$$

n can comprise a number of datapoints in a dataset, yᵢ can comprise actual value for an ith datapoint, ŷᵢ is a predictive value for the ith datapoint, and |yᵢ−ŷᵢ| is an absolute difference between the actual value and the predictive value.

SSIM measures a quality of an image by considering changes in overall structural information, luminance, and/or contrast. Structural information can be quantified by using pixel intensities. Luminance measures a similarity in brightness. Contrast measures a similarity in contrast. This can be compared to MAE, which measures pixel-wise differences between a predicted image and an actual image. Mathematically, SSIM can comprise:

$$SSIM ( x , y ) = {[ l ( x , y ) ]}^{α} \cdot {[ c ( x , y ) ]}^{β} \cdot {[ s ( x , y ) ]}^{γ}$$

α, β, and γ can comprise weights (e.g., parameters that control a relative importance of each bracketed term), l(x, y) can comprise a luminance, c(x, y) can comprise a contrast, and s(x, y) and can comprise structure for each image x and y.

Mathematically, luminance can comprise:

$$l ( x , y ) = \frac{2 {μ}_{x} {μ}_{y} + {C}_{1}}{{μ}_{x}^{2} + {μ}_{y}^{2} + {C}_{1}}$$

μₓ can comprise a mean intensity of image x, μ_{y} can comprise a mean intensity of image y, and C₁ can comprise a constant that stabilizes division when a denominator of luminance is small.

Mathematically, contrast can comprise:

$$c ( x , y ) = \frac{2 {σ}_{x} {σ}_{y} + {C}_{2}}{{σ}_{x}^{2} + {σ}_{y}^{2} + {C}_{2}}$$

σₓ can comprise a standard deviation of image x's contrast, μ_{y} can comprise a standard deviation of image y's contrast, and C₂ can comprise a constant that stabilizes division when a denominator of contrast is small.

Mathematically, structure can comprise:

$$s ( x , y ) = \frac{{σ}_{x y} + {C}_{3}}{{σ}_{x} {σ}_{y} + {C}_{3}}$$

σ_{xy} is a covariance between images x and y and C₃ is a constant related to C₂. In many embodiments,

$${C}_{3} = \frac{{C}_{2}}{2} .$$

When a value of a cost function is lowered, a more optimal value for a camera's position has been found. In various embodiments, an optimization algorithm can comprise a gradient descent algorithm. Gradient descent can proceed by using camera positional data to calculate a gradient for a cost function. A gradient can comprise a vector of partial derivatives of a cost function with respect to each camera positional datum. A gradient indicates a direction and rate of a steepest ascent in the cost function. After the gradient is calculated, camera positional data is updated in a direction opposite to the gradient. In many embodiments, finite difference gradients can be implemented in a gradient descent algorithm. Finite difference gradients can comprise a numerical method used to approximate a gradient of a function, thereby saving computing resources. Instead of calculating the gradient analytically (e.g., using calculus), finite difference methods estimate a gradient by evaluating a gradient function at nearby points and measuring a difference in gradient function values. Each camera datum (e.g., positional, 6-degrees of freedom, and/optical measurements) by E, smallest amount that would result in a change in the predicted image. Each datum is perturbed individually, rendered, and then compared to a ground truth image with a cost function in order to compute a gradient.

In various embodiments, camera positional data for a vehicle can be optimized similarly in a batch to improve processing speeds. For example, cameras for a full 360 degree image capture of a vehicle can have their positional data modulated by one round of an optimization algorithm. In many embodiments, positional data for images of a vehicle (both actual and predicted) can be modeled as a ring circumscribing the vehicle at one or more levels along, above, or below the vehicle. This ring can have its own six degrees of freedom and a radius. This, then, allows an angular movement along the ring (a stand-in for camera position in many embodiments) to be an optimizable element. In this way, camera positional data can be optimized by varying a rotational speed of a vehicle or angular speed of a camera traveling around a vehicle. Optimization of a camera ring can provide for a number of technical advantages by making an optimization algorithm faster and more accurate. This is due to a reduction in the number of variables considered optimizable. For example, for a 64 image, 360 degree image capture of an automobile, a non-ring optimization algorithm runs with 448 values while a camera ring optimization algorithm runs with 72 values.

All or a part of a first training process (e.g., training on a lower number and/or lower resolution of vehicle images and/or an optimization algorithm) can be repeated until positional data for one or more cameras are fine tuned for generating high detail, true to life images. For example, a first training process can be repeated until a cost function can no longer be lowered.

In various embodiments, method 100 can comprise an activity 104 of performing a second training process for a predictive algorithm. Activity 104 can be performed before, concurrently with, and/or after activity 103. A second training process can be used to make a predictive algorithm produce more detailed, true to life novel views of a vehicle. When GS is used as a predictive algorithm, a second training process can be used to determine optimal properties of each gaussian distribution. For example, an optimization algorithm can be used to alter properties of a Gaussian's mean and spread. As another example, a learning rate (e.g., a distance each splat can be moved at each training round) can start low (e.g., a learning rate of 0.00002 or ⅛^{th} of a default learning rate). In many embodiments, a learning rate can be increased or a training process can be restarted at a higher learning rate when a point cloud for a vehicle loses its shape and/or becomes amorphous. Amorphousness can be measured by comparing an in-progress render of a vehicle to a ground truth photograph of the vehicle using a cost function. If a point cloud is approximately shaped like a vehicle, then a cost function will return a value closer to 1.0. A threshold value (e.g., 0.1) can be set, and a point cloud can be deemed amorphous when a cost function returns a value under that value. As another example, a splat density (e.g., number of splats used) can be modulated. Splat density can be lowered to increase speed or raised to increase detail. It may be beneficial to initially (e.g., near or at a beginning) train at a lower density and then later (e.g., near or at an ending) train at a higher density. In this way, a second training process can iteratively improve a predicted image. Various algorithms can be used to modulate splat density. For example, a mathematical function (e.g., linear, logarithmic, etc.) can be used.

In various embodiments, method 100 can comprise an activity 105 of generating one or more novel views of the vehicle using the predictive algorithm. In various embodiments, GS can be used as described above to generate an image of a vehicle. In various embodiments, an image of a vehicle can be generated from a novel view (e.g., a view that was not captured by a camera). A novel view of a vehicle can be stored in a number of different locations after generation. For Example, novel views can be stored in a central repository (e.g., a server) for transmission to user computer systems. In other embodiments, novel views can be stored on a user device within a temporary storage (e.g., cache, cookies, etc.) for faster loading.

In various embodiments, method 100 can comprise an activity 106 of coordinating displaying at least one image of a novel view of the vehicle. In various embodiments, a novel view can be displayed on a website and/or in an application installed on a computer system (e.g., one or more of image capture system 210 (FIG. 2), image rendering system 230 (FIG. 2), 3D display system 250 (FIG. 2), and/or user computer 260 (FIG. 2)). For example, method 400 below illustrates an exemplary process for generating a website. In various embodiments, novel views can be used to generate a 3D display of an object, and a system can display one or more novel views of a vehicle as a user navigates around the 3D display. In various embodiments, a novel view can have a synthetic background. For example, a novel view can have a background removed and replaced or altered for privacy (e.g., blurred or pixelated). In various embodiments, novel views of a vehicle can be displayed as a video. For example, multiple novel and actual views of the vehicle can be appended together to generate a video. Novel views of a vehicle can be used to animate one or more portions of the vehicle. For example, a novel view can be used to animate wheels and/or a suspension of the vehicle.

Turning ahead in the drawings, FIG. 2 illustrates a block diagram of a system 200 that can be employed for rendering a portion of a 3D display, as described in greater detail below. System 200 is merely exemplary and embodiments of the system are not limited to the embodiments presented herein. System 200 can be employed in many different embodiments or examples not specifically depicted or described herein. In various embodiments, certain elements or modules of system 200 can perform various procedures, processes, and/or activities. In these or other embodiments, the procedures, processes, and/or activities can be performed by other suitable elements or modules of system 200.

Generally, therefore, system 200 can be implemented with hardware and/or software, as described herein. In various embodiments, part or all of the hardware and/or software can be conventional, while in these or other embodiments, part or all of the hardware and/or software can be customized (e.g., optimized) for implementing part or all of the functionality of system 200 described herein.

In various embodiments, system 200 can include an image capture system 210, an image rendering system 230, a 3D display system 250, and/or a user computer 260. Image capture system 210, image rendering system 230, 3D display system 250, and/or user computer 260 can each be a computer system, such as computer system 300 (FIG. 3), as described above, and can each be a single computer, a single server, or a cluster or collection of computers or servers, or a cloud of computers or servers. In another embodiment, a single computer system can host each of two or more of image capture system 210, image rendering system 230, 3D display system 250, and/or user computer 260. Additional details regarding image capture system 210, image rendering system 230, 3D display system 250, and/or user computer 260 are described herein.

In various embodiments, each of image capture system 210, image rendering system 230, 3D display system 250, and user computer 260 can be a separate system, such as computer system 300 (FIG. 3). In other embodiments, or two or more of image capture system 210, image rendering system 230, 3D display system 250, and user computer 260 can be combined into a single system, such as computer system 300 (FIG. 3). In any of the embodiments described in this paragraph, each separate system can be operated by a different entity or by a single entity, or two or more of each separate system can be operated by the same entity.

As noted above, In various embodiments, system 200 comprises user computer 260. In other embodiments, user computer 260 is external to system 200. User computer 260 can comprise any of the elements described in relation to computer system 300 (FIG. 3). In various embodiments, user computer 260 can be a mobile electronic device. A mobile electronic device can refer to a portable electronic device (e.g., an electronic device easily conveyed by hand by a person of average size) with the capability to present audio and/or visual data (e.g., text, images, videos, music, etc.). For example, a mobile electronic device can comprise at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile electronic device can comprise a volume and/or weight sufficiently small as to permit the mobile electronic device to be easily conveyable by hand. For example, in various embodiments, a mobile electronic device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile electronic device can weigh less than or equal to 15.6 Newtons, 17.8 Newtons, 22.3 Newtons, 31.2 Newtons, and/or 44.5 Newtons.

Exemplary mobile electronic devices can comprise (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile electronic device can comprise an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can comprise a mobile electronic device, and vice versa. However, a wearable user computer device does not necessarily comprise a mobile electronic device, and vice versa.

In specific examples, a wearable user computer device can comprise a head mountable wearable user computer device (e.g., one or more head mountable displays, one or more eyeglasses, one or more contact lenses, one or more retinal displays, etc.) or a limb mountable wearable user computer device (e.g., a smart watch). In these examples, a head mountable wearable user computer device can be mountable in close proximity to one or both eyes of a user of the head mountable wearable user computer device and/or vectored in alignment with a field of view of the user.

In more specific examples, a head mountable wearable user computer device can comprise (i) Google Glass™ product or a similar product by Google Inc. of Menlo Park, California, United States of America; (ii) the Eye Tap™ product, the Laser Eye Tap™ product, or a similar product by ePI Lab of Toronto, Ontario, Canada, and/or (iii) the Raptyr™ product, the STAR 1200™ product, the Vuzix Smart Glasses M100™ product, or a similar product by Vuzix Corporation of Rochester, New York, United States of America. In other specific examples, a head mountable wearable user computer device can comprise the Virtual Retinal Display™ product, or similar product by the University of Washington of Seattle, Washington, United States of America. Meanwhile, in further specific examples, a limb mountable wearable user computer device can comprise the iWatch™ product, or similar product by Apple Inc. of Cupertino, California, United States of America, the Galaxy Gear or similar product of Samsung Group of Samsung Town, Seoul, South Korea, the Moto 360 product or similar product of Motorola of Schaumburg, Illinois, United States of America, and/or the Zip™ product, One™ product, Flex™ product, Charge™ product, Surge™ product, or similar product by Fitbit Inc. of San Francisco, California, United States of America.

In various embodiments, system 200 can comprise a graphical user interface (“GUI”). In the same or different embodiments, a GUI can be part of and/or displayed by image capture system 210, image rendering system 230, 3D display system 250, and/or user computer 260, and also can be part of system 200. In various embodiments, a GUI can comprise text and/or graphics (image) based user interfaces. In the same or different embodiments, a GUI can comprise a heads up display (“HUD”). When a GUI comprises a HUD, the GUI can be projected onto glass or plastic, displayed in midair as a hologram, or displayed on a display. In various embodiments, a GUI can be color, black and white, and/or greyscale. In various embodiments, a GUI can comprise an application running on a computer system, such as computer system 300 (FIG. 3), image capture system 210, image rendering system 230, 3D display system 250, and/or user computer 260. In the same or different embodiments, a GUI can comprise a website accessed through internet 220. In various embodiments, a GUI can comprise an eCommerce website. In these or other embodiments, a first GUI can comprise an administrative (e.g., back end) GUI allowing an administrator to modify and/or change one or more settings in system 200 while another GUI can comprise a consumer facing (e.g., a front end) GUI. In the same or different embodiments, a GUI can be displayed as or on a virtual reality (VR) and/or augmented reality (AR) system or display. In various embodiments, an interaction with a GUI can comprise a click, a look, a selection, a grab, a view, a purchase, a bid, a swipe, a pinch, a reverse pinch, etc.

In various embodiments, image capture system 210, image rendering system 230, 3D display system 250, and/or user computer 260 can be in data communication through internet 220 with each other and/or with user computer 260. In certain embodiments, as noted above, user computer 260 can be desktop computers, laptop computers, smart phones, tablet devices, and/or other endpoint devices. Image capture system 210, image rendering system 230, and/or 3D display system 250 can host one or more websites. For example, 3D display system 250 can host an eCommerce website that allows users to browse and/or search for products, to add products to an electronic shopping cart, and/or to purchase products, in addition to other suitable activities.

In various embodiments, image capture system 210, image rendering system 230, 3D display system 250, and/or user computer 260 can each comprise one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can comprise a keyboard and/or a mouse. Further, one or more of the display device(s) can comprise a monitor and/or embedded screen. The input device(s) and the display device(s) can be coupled to the processing module(s) and/or the memory storage module(s) image capture system 210, image rendering system 230, 3D display system 250, and/or user computer 260 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processing module(s) and/or the memory storage module(s). In various embodiments, the KVM switch also can be part of image capture system 210, image rendering system 230, 3D display system 250, and/or user computer 260. In a similar manner, the processing module(s) and the memory storage module(s) can be local and/or remote to each other.

As noted above, In various embodiments, image capture system 210, image rendering system 230, 3D display system 250, and/or user computer 260 can be configured to communicate with user computer 260. In various embodiments, user computer 260 also can be referred to as customer computers. In various embodiments, image capture system 210, image rendering system 230, 3D display system 250, and/or user computer 260 can communicate or interface (e.g., interact) with one or more customer computers (such as user computer 260) through a network or internet 220. Internet 220 can be an intranet that is not open to the public. In further embodiments, Internet 220 can be a mesh network of individual systems. Accordingly, In various embodiments, image capture system 210, image rendering system 230, and/or 3D display system 250 (and/or the software used by such systems) can refer to a back end of system 200 operated by an operator and/or administrator of system 200, and user computer 260 (and/or the software used by such systems) can refer to a front end of system 200 used by one or more users. In these embodiments, the components of the back end of system 200 can communicate with each other on a different network than the network used for communication between the back end of system 200 and the front end of system 200. In various embodiments, the users of the front end of system 200 can also be referred to as customers, in which case, user computer 260 can be referred to as a customer computer. In these or other embodiments, the operator and/or administrator of system 200 can manage system 200, the processing module(s) of system 200, and/or the memory storage module(s) of system 200 using the input device(s) and/or display device(s) of system 200.

Meanwhile, In various embodiments, image capture system 210, image rendering system 230, 3D display system 250, and/or user computer 260 also can be configured to communicate with one or more databases. The one or more databases can comprise a product database that contains information about products, items, automobiles, or SKUs (stock keeping units) sold by a retailer. The one or more databases can be stored on one or more memory storage modules (e.g., non-transitory memory storage module(s)), which can be similar or identical to the one or more memory storage module(s) (e.g., non-transitory memory storage module(s)) described above with respect to computer system 300 (FIG. 3). Also, in various embodiments, for any particular database of the one or more databases, that particular database can be stored on a single memory storage module of the memory storage module(s), and/or the non-transitory memory storage module(s) storing the one or more databases or the contents of that particular database can be spread across multiple ones of the memory storage module(s) and/or non-transitory memory storage module(s) storing the one or more databases, depending on the size of the particular database and/or the storage capacity of the memory storage module(s) and/or non-transitory memory storage module(s).

The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, IBM DB2 Database, and/or NoSQL Database.

Meanwhile, communication between image capture system 210, image rendering system 230, 3D display system 250, and/or user computer 260, and/or the one or more databases can be implemented using any suitable manner of wired and/or wireless communication. Accordingly, system 200 can comprise any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can comprise Bluetooth, Zigbee, Wireless Universal Serial Bus (USB), Z-Wave, etc.; exemplary LAN and/or WAN protocol(s) can comprise Institute of Electrical and Electronic Engineers (IEEE) 802.3 (also known as Ethernet), IEEE 802.11 (also known as WiFi), etc.; and exemplary wireless cellular network protocol(s) can comprise Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In various embodiments, exemplary communication hardware can comprise wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can comprise wireless communication hardware including, for example, one or more radio transceivers, one or more infrared transceivers, etc. Additional exemplary communication hardware can comprise one or more networking components (e.g., modulator-demodulator components, gateway components, etc.).

Turning ahead in the drawings, FIG. 3 illustrates a block diagram of a system 300 that can be employed for generating an image of an automobile, as described in greater detail below. System 300 is merely exemplary and embodiments of the system are not limited to the embodiments presented herein. System 300 can be employed in many different embodiments or examples not specifically depicted or described herein. In various embodiments, certain elements or modules of system 300 can perform various procedures, processes, and/or activities. In these or other embodiments, the procedures, processes, and/or activities can be performed by other suitable elements or modules of system 300.

Generally speaking, system 300 can be implemented with hardware and/or software. Part or all of the hardware and/or software implemented in system 300 can be conventional or part or all of the hardware and/or software can be customized (e.g., optimized) for implementing part or all of the functionality of system 300 described herein. When implemented as software, one or more elements of system 300 can be emulated (e.g., reproduced functionally and/or by action via software). For example, a virtual machine having one or more elements described below can be instantiated on one or more elements of system 200 (FIG. 2).

When implemented as hardware, one or more of the elements of system 300 can be coupled together using one or more chassis configured to hold one or more circuit boards and/or serial bus(es). These boards and buses allow the various elements of system 300 to communicate amongst each other to accomplish their intended purposes. While elements of system 300 are described below individually, each can also be integrated into one or more chassis, circuit boards, and/or buses of system 300. On the other hand, one or more elements of system 300 can also be removable (e.g., via a PCI slot on a motherboard and/or a USB port). One or more elements of system 300 may also be integrated and/or embedded in a different machine or manufacture. Although specific constructions of boards and buses within system 300 are not shown, it should be understood that their construction can be tied to a form factor selected for system 300.

System 300 can take a number of different form factors based on its implementation. For example, system 300 can be implemented as a desktop computer, a laptop computer, a mobile device, and/or a wearable device as described herein. Further, system 300 can comprise a single computer, a single server, a cluster or collection of computers or servers, or a cloud of computers or servers. Typically, a cluster or collection of servers can be used when the demand on 300 exceeds the reasonable capability of a single server or computer, when a distributed structure for system 300 is desired, and/or when parallel computing is desired.

In various embodiments, system 300 can comprise a processor 301, a memory storage 302, an input device 303, a graphics adapter 304, a display device 305, a graphical user interface (GUI) 306, a network adapter 307, and/or an audio output 308.

Generally speaking, processor 301 can comprise any type of computational circuit. For example, processor 301 can comprise a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, application specific integrated circuits (ASICs), etc. Processor 301 can be configured to implement (e.g., run) computer instructions (e.g., program instructions) stored on memory devices in system 300. At least a portion of the program instructions, stored on these devices, can be suitable for carrying out at least part of the functions and methods described herein. Architecture and/or design of processor 301 can be compliant with any of a variety of commercially distributed architecture families. For example, a processor can have a 32-bit (x86) architecture and/or a 64-bit (x86-64, IA64, and AMD64) architecture. Processor 301 can be configured to perform parallel computing in combination with other elements of system 300 and/or additional processors. Generally speaking, parallel computing can be seen as a technique where multiple elements of system 300 are used to perform calculations simultaneously. In this way, complex and repetitive tasks (e.g., training a predictive algorithm) can be performed faster and with less processing power than without parallel computing.

Generally speaking, memory storage 302 can comprise non-volatile memory (e.g., read only memory (ROM)) and/or volatile memory (e.g., random access memory (RAM)). The non-volatile memory can be removable and/or non-removable non-volatile memory. Meanwhile, RAM can comprise dynamic RAM (DRAM), static RAM (SRAM), or some other type of RAM. Further, ROM can include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), or some other type of ROM. Memory storage 302 can comprise non-transitory memory and/or transitory memory. All or a portion of memory storage 302 can be referred to as memory storage module(s) and/or memory storage device(s). Memory storage 302 can have a number of form factors when used in system 300. For example, memory storage 302 can comprise a magnetic disk hard drive, a solid state hard drive, a removable USB storage drive, a RAM chip, etc.

Memory storage 302 can be encoded with a wide variety of computer code configured to operate system 300. For example, portions of memory storage 302 can be encoded with a boot code sequence suitable for restoring system 300 to a functional state after a system reset. As another example, portions of memory storage 302 can comprise microcode such as a Basic Input-Output System (BIOS) operable with elements of system 300. Further, portions of the memory storage 302 can comprise an operating system (e.g., a software program that manages the hardware and software resources of a computer and/or a computer network). The BIOS can be configured to initialize and test components of system 300 and load the operating system. Meanwhile, the operating system can perform basic tasks such as, for example, controlling and allocating memory, prioritizing the processing of instructions, controlling input and output devices, facilitating networking, and/or managing files. Exemplary operating systems can comprise software within the Microsoft® Windows®, Mac OS®, Apple® iOS®, Google® Android®, UNIX®, and/or Linux® series of operating systems.

Input device 303 can be configured to allow a user to interact and/or control elements of system 300. A number of devices can be used as input device 303 alone or in combination. For example, input device 303 can comprise a keyboard, a mouse, a touch screen, a microphone, a camera, etc. Input device 303 can be coupled to other elements of system 300 in a number of ways. For example, input device 303 can be coupled via a Universal Serial Bus (USB) port in a wired and/or wireless manner or via a specialized port (e.g., a PS/2 port) depending on the specific device. User inputs through input device 303 can come in a number of forms. For example, when input device 303 comprises a microphone, user input can be received via voice commands and/or a speech to text algorithm. As another example, when input device 303 comprises a camera, user input can be received via bodily movements that are captured and interpreted by system 300.

Generally speaking, graphics adapter 304 can be configured to receive and/or generate one or more elements for display on display device 305. Exemplary embodiments of graphics adapter 304 can comprise devices within the NVIDIA® GeForce® and/or the AMD® RX® series of video cards. In various embodiments, a chipset present on graphics adapter 304 can be configured to perform similar, simultaneous computations in a manner more efficient than other chipsets. For example, rendering a 3D scene on graphics adapter 304 can involve repeated geometric calculations performed in parallel to generate the 3D scene. As another example, repeated mathematical calculations involved in training a predictive algorithm can be performed in parallel on graphics adapter 304 more efficiently than on processor 301. Display device 305 can receive and display signals from graphics adapter 304. A number of devices can be used as display device 305. For example, display device 305 can comprise a computer monitor, a television, a touch screen display, a heads up display (HUD) medium, etc.

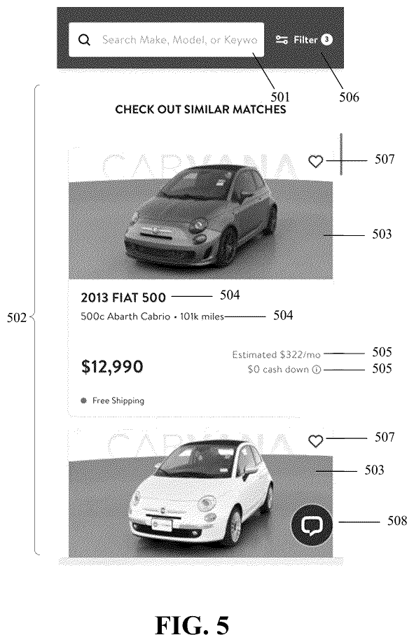

In various embodiments, display device 305 can optionally display graphical user interface (GUI) 306. GUI 306 can be a part of and/or displayed by one or more web devices 202-203 (FIG. 2). GUI 306 (or elements thereof) can also be stored 3D display system 250 and/or user computer 260. With regards to form, GUI 306 can comprise text and/or graphics (image) based user interfaces. For example, GUI 306 can comprise GUI 500 (FIG. 5)). As another example, GUI 306 can comprise a heads up display (HUD). When GUI 306 comprises a HUD, GUI 306 can be projected onto a medium (e.g., glass, plastic, metal, etc.), displayed in midair as a hologram, and/or displayed on display device 305. GUI 306 can be color, black and white, and/or greyscale. GUI 306 can be implemented as an application running on a computer system, such as 3D display system 250 and/or user computer 260. GUI 306 can also comprise a website accessed through a network (e.g., internet 220 (FIG. 2)). For example, GUI 306 can comprise a website or installed software application. When GUI 306 allows for modification and/or changes to one or more settings in system 300, it can be referred to as an administrative (e.g., back end) GUI. GUI 306 can also be displayed as or on a virtual reality (VR) and/or augmented reality (AR) system or display. GUI 306 can receive a number of interactions from a user via input device 303. For example, an interaction with a GUI can comprise a click, a look, a selection, a grab, a view, a purchase, a bid, a swipe, a pinch, a reverse pinch, etc.

Network adapter 307 can be configured to connect system 300 to a computer network by wired communication (e.g., a wired network adapter) and/or wireless communication (e.g., a wireless network adapter). Network adapter 307 can be integrated into one or more chassis, circuit boards, and/or buses or be removable (e.g., via a PCI slot on a motherboard). For example, network adapter 307 can be implemented via one or more dedicated communication chips configured to receive various protocols of wired and/or wireless communications. Audio output 308 can be configured to receive and/or generate one or more audio signals for play through a speaker and/or microphone. Exemplary audio outputs can comprise an audio card.

Camera 309 can comprise a variety of internal and external cameras capable of capturing digital images. For example, camera 309 can comprise a digital single-lens reflex (DSLR) camera, a mirrorless camera, a point-and-shoot camera, a bridge camera, an action camera, a 360-degree camera, a medium format camera, a smartphone camera, a drone camera, etc. Camera 309 can communicate with additional elements of system 300 via wired and/or wirelessly communication. When wired, camera 309 can be integrated into system 300 (e.g., a smartphone camera) or coupled via one or more removable cables. Camera 309 can comprise one or more removable storage mediums capable of transferring stored photographs for transfer to other systems.

Turning ahead in the drawings, FIG. 4 illustrates a flow chart for a method 400, according to various embodiments. Method 400 is merely exemplary and is not limited to the embodiments presented herein. Method 400 can be employed in many different embodiments or examples not specifically depicted or described herein. In various embodiments, the activities of method 400 can be performed in the order presented. In other embodiments, the activities of method 400 can be performed in any suitable order. In still other embodiments, one or more of the activities of method 400 can be combined or skipped. In various embodiments, system 200 (FIG. 2) or system 300 (FIG. 3) can be suitable to perform method 400 and/or one or more of the activities of method 400. In these or other embodiments, one or more of the activities of method 400 can be implemented as one or more computer instructions configured to run at one or more processing modules and configured to be stored at one or more non-transitory memory storage modules. Such non-transitory memory storage modules can be part of a computer system such as image capture system 210 (FIG. 2), image rendering system 230 (FIG. 2), 3D display system 250 (FIG. 2), and/or user computer 260 (FIG. 2). The processing module(s) can be similar or identical to the processing module(s) described above with respect to computer system 300 (FIG. 3).

In various embodiments, method 400 comprises an activity 401 of receiving one or more uniform resource locators (URLs) of one or more media files. The media file(s) may comprise one or more images of a vehicle. In various embodiments, the media file(s) may comprise a 360-degree view of a vehicle generated from the combination of the one or more images of the vehicle. In various embodiments, the media file(s) may comprise images generated from system 200. In various embodiments, the media file(s) may be static images displaying one or more views of the vehicle. In various embodiments, the media file(s) may be active, such that a short highlight video can be played, the highlight video comprising the 360-degree view of the vehicle and/or an overview of the vehicle's features.

In various embodiments, activity 401 of receiving the one or more URLs of one or more media files comprises a request-driven (pull) approach, wherein a developer, via a computer system, such as system 200 (FIG. 2), may send a request to one or more databases, such as the one or more databases used in system 200 (FIG. 2) or system 300 (FIG. 3), for the URL(s) associated with the stock number for a desired vehicle. The pull approach may further comprise an authentication and authorization process, comprising obtaining a bearer token, via the one or more databases, and including said token in the request. In various embodiments, once receiving the request, the one or more databases transmit the URL(s) to the computer system. In various embodiments, a URL may not exist for a specified stock number. In such embodiments, upon receiving a request, the one or more databases may transmit an error code to the computer system. The error code may be an indicator message, such as 404 error, may display an empty file, and/or any indication that the URL does not exist.

In other embodiments, activity 401 of receiving one or more URLs of one or more media files comprises an event-driven (push) approach, wherein in response to a media file being associated with a stock number for a desired vehicle in the one or more databases, an event is sent to a Service Bus Topic, electronically communicating the URL(s) from the one or more databases to the computer system. In such embodiments, the push approach removes the need for continuous polling.

In various embodiments, method 400 further comprises activity 402 integrating the URL(s) into a GUI. In various embodiments, the GUI can comprise a website accessed through the internet, such as internet 220 (FIG. 2). In various embodiments, the URL(s) may be integrated into one or more tiles displayed on the GUI. For example, the GUI may comprise a search function, wherein in response to a user entering a specific query, a Search Results Page (SRP) comprising one or more tiles of vehicles that match the query are displayed.

Method 400 further comprises activity 403 loading and playing the media file(s). As the user interacts, via a user computer, such as user computer 260 (FIG. 2), with the tile(s), the media file begins to load and play. Interacting with the tile(s) may comprise a user clicking on it, hovering their indicator over it, ceasing scrolling through the GUI while the tile is displayed, and/or any action suitable to trigger the media file to begin loading.

In various embodiments, the media file(s) are not pre-loaded and utilize lazy loading to ensure efficient loading. In various embodiments, there may be a delay between the user interacting with the tile(s) and the loading and playing of the media files(s) in order to reduce initial load times and conserve bandwidth. In various embodiments, the delay may be in the range of about 0 milliseconds to about 1000 milliseconds, preferably about 100 milliseconds to about 750 milliseconds, more preferably about 250 milliseconds to about 500 milliseconds.

In various embodiments, every URL associated with the same stock number is integrated into the same tile and their corresponding media files are configured to play subsequent to one another. In various embodiments, a new media file is triggered to begin loading and playing with each tile interaction. For example, if a user ceases scrolling, triggering a first media file to begin playing, then scrolls away, the interaction is complete. Then, should the user scroll back to the same tile and cease scrolling, a second media file is triggered to begin playing.

In such embodiments, a selection logic may comprise maintaining a global (per page load) ‘videoIndex’ variable that starts at 0, wherein each media file is associated with a videoIndex value. Each time an interaction occurs, the current value of videoIndex is used to select the corresponding media file. After the interaction is complete, the videoIndex variable is increased by one value. The media file does not need to be played to the end to enable a new media file from being triggered upon a new interaction occurring. In other embodiments, should the user watch one media file to the end without completing the interaction and starting a new interaction, the videoIndex variable is not increased, and the same media file is looped until the interaction is complete.

In various embodiments, and as noted above, the media file may be a static image and not a video. In the event that an error occurs with loading and/or playing, the tile(s) may display the static image. In various embodiments, the media file(s) may be constrained to a certain size to minimize the impact of network latency and bandwidth limitations. In various embodiments, the media file(s) may be on the order of less than about 1000 kilobytes, preferably on the order of less than about 500 kilobytes, more preferably on the order of less than about 300 kilobytes.

Turning now to FIG. 5, an embodiment of a GUI 500 is shown. GUI 500 is merely exemplary and is not limited to the embodiments presented herein. GUI 500 can be employed in many different embodiments or examples not specifically depicted or described herein. In various embodiments, the elements of GUI 500 can be arranged as shown in FIG. 5. In other embodiments, the elements of GUI 500 can be arranged in any suitable arrangement. In still other embodiments, one or more of the activities of GUI 500 can be combined or omitted. In various embodiments, system 200 (FIG. 2) and/or system 300 (FIG. 3) can be suitable for coordinating displaying GUI 500 and/or one or more elements of GUI 500. In these or other embodiments, one or more elements of GUI 500 can be implemented as one or more computer instructions configured to run at one or more processing modules and configured to be stored at one or more non-transitory memory storage modules. Such non-transitory memory storage modules can be part of a computer system such as image capture system 210 (FIG. 2), image rendering system 230 (FIG. 2), 3D display system 250 (FIG. 2), and/or user computer 260 (FIG. 2). The processing module(s) can be similar or identical to the processing module(s) described above with respect to computer system 300 (FIG. 3). In various embodiments, one or more activities and/or elements from method 400 may be used with GUI 500.

In various embodiments, GUI 500 can comprise a GUI for searching for and viewing vehicles that match a search query 501 entered by a user. The search query may be, for example, a specific vehicle make, model, color, body type, and/or any combination of the same. In response to the user entering search query 501, an SRP 502 is generated, displaying one or more tile(s) 503, such as the tile(s) from method 400, of all relevant vehicles that match search query 501 to the user. Tile(s) 503 may comprise static or active media files configured to load and play in response to an interaction from the user, such as, for example, as is disclosed in method 400. GUI 500 may further comprise description data 504 and pricing data 505 about the generated tile(s) 503. GUI 500 may further comprise a filtering tool 506, configured to allow the user to sort the tile(s) 503 by various features, such as mileage or cost, and refine the SRP 502 to display more relevant results. The user may save vehicles they are most interested in through a bookmarking function 507, allowing the user to quickly refer back to desired vehicles. In various embodiments, GUI 500 may be displayed on a user computer, such as user computer 260 (FIG. 2). In various embodiments, GUI 500 can comprise a website accessed through the internet, such as internet 220 (FIG. 2). In various embodiments, GUI 500 may comprise a chat function 508, configured to connect a user with an operator. The operator may be a chat bot or a human operator.

For simplicity and clarity of illustration, the drawing figures illustrate the general manner of construction, and descriptions and details of some features and functions may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in various embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, In various embodiments, the time delay can be less than approximately one second, two seconds, five seconds, or ten seconds.

As defined herein, “approximately” can, in various embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Although systems and methods for generating an image of a vehicle have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIG. 1 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory memories storing computing instructions configured to communicate with the one or more processors and cause the one or more processors to perform:
estimating one or more camera positions using one or more images of a vehicle;
performing a first training process for a predictive algorithm using the one or more images of the vehicle;
after the first training process has started, performing a second training process for the predictive algorithm using the one or more images of the vehicle, wherein the second training process is different from the first training process;
generating one or more novel views of the vehicle using the predictive algorithm; and
after the second training process has started, coordinating displaying at least one image of the one or more novel views of the vehicle.

2. The system of claim 1, wherein the estimating the one or more camera positions comprises modeling the one or more camera positions as a ring of cameras surrounding the vehicle.

3. The system of claim 1, wherein the first training process comprises optimizing one or more sets of camera positional data.

4. The system of claim 1, wherein the second training process comprises optimizing a mean and spread of a gaussian distribution.

5. The system of claim 1, wherein the coordinating displaying the at least one image comprises coordinating displaying a video comprising the at least one image of the one or more novel views of the vehicle.

6. The system of claim 5, wherein the video comprises an animation of one or more wheels on the vehicle or one or more suspensions on the vehicle.

7. The system of claim 1, wherein the coordinating displaying the at least one image comprises coordinating displaying a website comprising the at least one image of the one or more novel views of the vehicle.

8. A method comprising:
estimating one or more camera positions using one or more images of a vehicle;
performing a first training process for a predictive algorithm using the one or more images of the vehicle;
after the first training process has started, performing a second training process for the predictive algorithm using the one or more images of the vehicle, wherein the second training process is different from the first training process;
generating one or more novel views of the vehicle using the predictive algorithm; and
after the second training process has started, coordinating displaying at least one image of the one or more novel views of the vehicle.

9. The method of claim 8, wherein the estimating the one or more camera positions comprises modeling the one or more camera positions as a ring of cameras surrounding the vehicle.

10. The method of claim 8, wherein the first training process comprises optimizing one or more sets of camera positional data.

11. The method of claim 8, wherein the second training process comprises optimizing a mean and spread of a gaussian distribution.

12. The method of claim 8, wherein the coordinating displaying the at least one image comprises coordinating displaying a video comprising the at least one image of the one or more novel views of the vehicle.

13. The method of claim 12, wherein the video comprises an animation of one or more wheels on the vehicle or one or more suspensions on the vehicle.

14. The method of claim 8, wherein the coordinating displaying the at least one image comprises coordinating displaying a website comprising the at least one image of the one or more novel views of the vehicle.

15. One or more articles of manufacture including one or more non-transitory, tangible computer readable storage mediums having instructions stored thereon that, in response to execution by one or more processors, cause the one or more processors to perform:
estimating one or more camera positions using one or more images of a vehicle;
performing a first training process for a predictive algorithm using the one or more images of the vehicle;
after the first training process has started, performing a second training process for the predictive algorithm using the one or more images of the vehicle, wherein the second training process is different from the first training process;
generating one or more novel views of the vehicle using the predictive algorithm; and
after the second training process has started, coordinating displaying at least one image of the one or more novel views of the vehicle.

16. The one or more articles of manufacture of claim 15, wherein the estimating the one or more camera positions comprises modeling the one or more camera positions as a ring of cameras surrounding the vehicle.

17. The one or more articles of manufacture of claim 15, wherein the first training process comprises optimizing one or more sets of camera positional data.

18. The one or more articles of manufacture of claim 15, wherein the second training process comprises optimizing a mean and spread of a gaussian distribution.

19. The one or more articles of manufacture of claim 15, wherein the coordinating displaying the at least one image comprises coordinating displaying a video comprising the at least one image of the one or more novel views of the vehicle.

20. The system of claim 19, wherein the video comprises an animation of one or more wheels on the vehicle or one or more suspensions on the vehicle.
